(19) United States
(12) Patent Application Publication
(10) Pub. No.: US 2013/0279373 A1
(43) Pub. Date: Oct. 24, 2013

(54) METHOD AND APPARATUS FOR PROVIDING AN INTERNET PROTOCOL MULTIMEDIA SUBSYSTEM TRIGGERING SERVICE

(71) Applicant: INTERDIGITAL PATENT HOLDINGS, INC., Wilmington, DE (US)

(72) Inventors: Zongrui Ding, San Diego, CA (US); Michael F. Starsinic, Newtown, PA (US); Chonggang Wang, Princeton, NJ (US); Kamel M. Shaheen, King of Prussia, PA (US); Guang Lu, Montreal (CA); Dale N. Seed, Allentown, PA (US); Qing Li, Princeton Junction, NJ (US); Lijun Dong, San Diego, CA (US)

(21) Appl. No.: 13/865,792

(22) Filed: Apr. 18, 2013

Related U.S. Application Data
(60) Provisional application No. 61/625,898, filed on Apr. 18, 2012.

(51) Int. Cl. H04M 15/00

(52) U.S. Cl. CPC H04M 15/56
USPC 370/259

(57) ABSTRACT

A method and apparatus are described for providing triggering services over multiple access networks. A triggering service server (TSS) architecture includes a triggering identity function (TIF) which maintains a database of device and application identifier mappings across multiple access networks, triggering capabilities and triggering preferences. The TSS also includes a triggering decision function (TDF) that uses information from the TIF and determines how triggers should be performed towards a device and/or an application hosted on a particular device. The TSS also includes triggering gateways (T-GWs) that perform triggering in different domains. A “not-registered-triggerable” state may be used to indicate whether an entity, such as a device, application or user can receive triggers although it is not registered in a specific access network. Methods and apparatus are also described for implementing various unassisted triggering and assisted triggering procedures using wireless transmit/receive units (WTRUs), application servers (ASs) and service capability servers (SCSs).

### CROSS REFERENCE TO RELATED APPLICATIONS

This application claims the benefit of U.S. provisional application No. 61/625,898 filed Apr. 18, 2012, which is incorporated by reference as if fully set forth herein.

### BACKGROUND

The Internet protocol (IP) multimedia subsystem (IMS) is a session control layer that overlays an IP transport layer. The IMS architecture is primarily intended to facilitate multimedia applications, such as streaming video and voice with quality of service (QoS).

The IMS network was originally proposed to facilitate human interactions, such as voice over IP (VoIP). On an IMS control plane, a session initiation protocol (SIP) may be used to initiate, manage and control sessions. IMS users may be registered to the IMS domain if available to communicate. Currently, upon receiving a message towards a wireless transmit/receive unit (WTRU) without an active IMS registration, an IMS core network (CN) will respond with an unsuccessful SIP message. Thus, a WTRU that does not maintain an active registration in the IMS domain may not be reachable from the IMS domain.

There are cases where it would be more efficient to allow devices to de-register from the IMS CN during periods of inactivity, but remain reachable so that other IMS applications may request a session initiation. For example, it may be inefficient for a universal mobile telecommunications system (UMTS) device that communicates infrequently, such as a machine-type communications (MTC) device, to maintain its IMS registration and the associated overhead when not communicating. The associated overhead may include an active packet data protocol (PDP) context and an IP address. Additionally, the IMS or third generation partnership project (3GPP) CN may wish to schedule devices such that they do not all connect to the network at the same time.

In a 3GPP network, an MTC inter-working function (IWF) may perform triggering service where trigger messages can be sent when MTC devices are not reachable from the 3GPP CN. Similarly, the IMS CN may trigger IMS devices/applications that are not registered to the IMS CN, but reachable from 3GPP CN through the MTC-IWF. The IMS applications that desire to initiate a session with another IMS application that is not registered in IMS may then trigger the un-registered application, thus prompting it to register. Currently, there is no triggering functionality available from the IMS domain.

In addition, no matter which entity handles triggering service, there may be identifier ambiguity in IMS triggering service by a SIP uniform resource identifier (URI). The current IMS identifier structure is designed for users, not for devices. The IP multimedia private user identity (IMPI) may be assigned by the network operator and used for registration, authorization, administration and accounting purposes. The IMPI may not be used for routing SIP messages and may take the form of a network access identifier (NAI). Thus, it may not be possible for the WTRU to modify the IMPI information stored on the IMS subscriber identity module (ISIM) application or IMS credentials (IMC). Each IMS user may have one or more IP multimedia public user identity (IMPU) including at least one taking the form of a SIP URI. The IMPU may be used by any user for requesting communications to other users.

In the IMS domain, an MTC device/application identifier may take the form of an IMPU. An IMPU may be registered before initiating or terminating sessions. Also, not all IMPUs may be stored in the IMS home subscriber server (HSS). An unregistered IMPU may be either not stored in HSS or correspond to multiple IMPIs. Thus, when a trigger message is sent towards an IMPU not registered in IMS, both the IMS and 3GPP domains may not be able to map it to a 3GPP internal identifier, (e.g., international mobile subscriber identity (IMSI). Although a globally routable user agent URI (GRUU) may be the identifier in IMS to address a unique combination of an IMPU and a WTRU instance, it may be assigned during registration and may not be used for triggering without a valid IMS registration.

### SUMMARY

A method and apparatus are described for providing triggering services over multiple access networks. A triggering service server (TSS) architecture includes a triggering identity function (TIF) which maintains a database of device and application identifier mappings across multiple access networks, triggering capabilities and triggering preferences. The TSS also includes a triggering decision function (TDF) that uses information from the TIF and determines how triggers should be performed towards a device and/or an application hosted on a particular device. The TSS also includes triggering gateways (T-GWs) that perform triggering in different domains. A “not-registered-triggerable” state may be used to indicate whether an entity, such as a device, application or user can receive triggers although it is not registered in a specific access network. Methods and apparatus are also described for implementing various unassisted triggering and assisted triggering procedures using wireless transmit/receive units (WTRUs), application servers (ASs) and service capability servers (SCSs).

### BRIEF DESCRIPTION OF THE DRAWINGS

A more detailed understanding may be had from the following description, given by way of example in conjunction with the accompanying drawings wherein:

FIG. 1A shows an example communications system in which one or more disclosed embodiments may be implemented;

FIG. 1B shows an example wireless transmit/receive unit (WTRU) that may be used within the communications system shown in FIG. 1A;

FIG. 1C shows an example radio access network and an example core network that may be used within the communications system shown in FIG. 1A;

FIG. 2 shows an Internet protocol (IP) multimedia subsystem (IMS) architecture;

FIG. 3 shows a third generation partnership project (3GPP) architecture for machine-type communications (MTC);

FIG. 4 shows an IMS architecture for providing short message service (SMS);

FIG. 5 shows IMS call flow destined to an unregistered wireless transmit/receive unit (WTRU);

FIG. 6 shows an IMS identifier structure;

FIG. 7 shows an example trigger service server (TSS) architecture;

FIG. 8 shows an example unassisted triggering architecture;

FIG. 9 shows information contained in a triggering short message (TSM) in a session initiation protocol (SIP) or hypertext transfer protocol (HTTP) message;

FIG. 10 shows an example unassisted triggering call flow;

FIG. 11 shows an example TSS architecture by reusing an MTC interworking function (MTC-IWF) as an application server (AS);

FIG. 12 shows an example call flow of TSS triggering by reusing MTC-IWF (AS originated (AS-O));

FIG. 13 shows an example TSS architecture by reusing the MTC-IWF through Tsp′;

FIG. 14 shows an example call flow of TSS triggering by reusing the MTC-IWF (mobile originated (MO));

FIG. 15 shows an example triggering through a service capability server (SCS);

FIG. 16 shows an example call flow for unassisted triggering through an SCS; and

FIG. 17 shows an example call flow for assisted triggering through an SCS.

### DETAILED DESCRIPTION

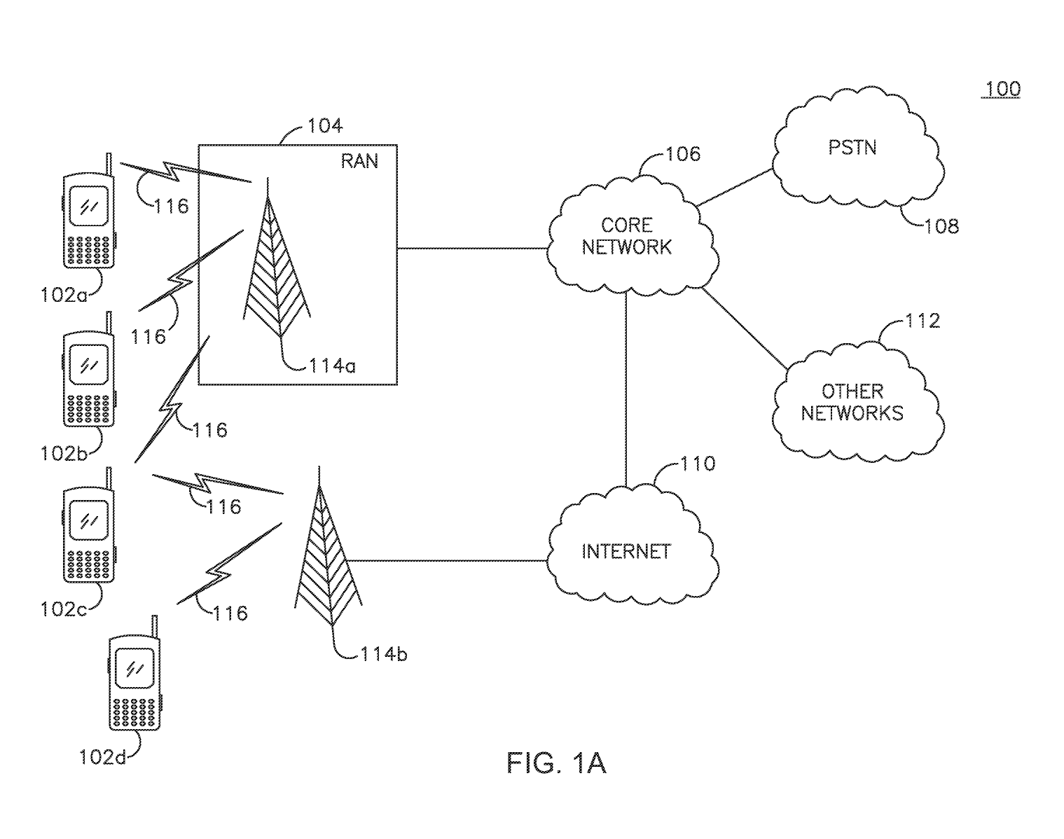

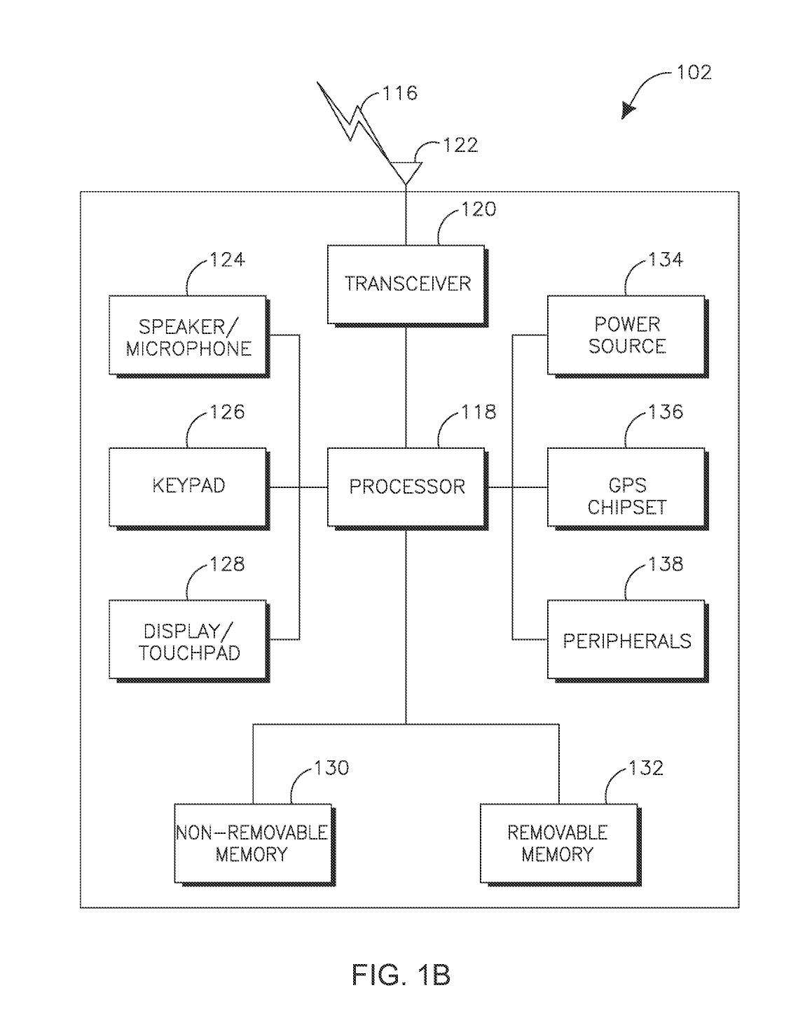

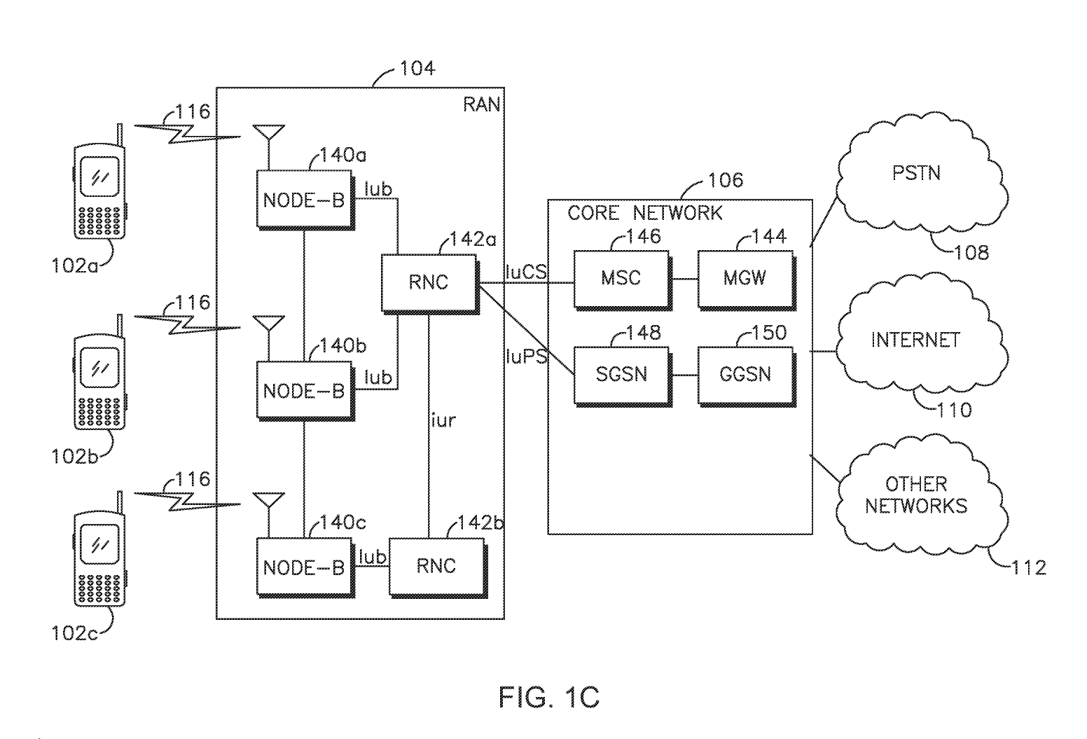

FIG. 1A shows an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an evolved Node-B (eNB), a Home Node-B (HNB), a Home eNB (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, and the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink packet access (HSDPA) and/or high-speed uplink packet access (HSUPA).

In another embodiment, the base station 114a and the WTRUs 102a, 102b, 102c may implement a radio technology such as evolved UTRA (E-UTRA), which may establish the air interface 116 using long term evolution (LTE) and/or LTE-Advanced (LTE-A).

In other embodiments, the base station 114a and the WTRUs 102a, 102b, 102c may implement radio technologies such as IEEE 802.16 (i.e., worldwide interoperability for microwave access (WiMAX)), CDMA2000, CDMA2000 1X, CDMA2000 evolution-data optimized (EV-DO), Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), and the like.

The base station 114b in FIG. 1A may be a wireless router, HNB, HeNB, or AP, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT, (e.g., WCDMA, CDMA2000, GSM, LTE, LTE-A, and the like), to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over Internet protocol (VoIP) services to one or more of the WTRUs 102a, 102b, 102c, 102d. For example, the core network 106 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B shows an example WTRU 102 that may be used within the communications system 100 shown in FIG. 1A. As shown in FIG. 1B, the WTRU 102 may include a processor 118, a transceiver 120, a transmit/receive element, (e.g., an antenna), 122, a speaker/microphone 124, a keypad 126, a display/touchpad 128, a non-removable memory 130, a removable memory 132, a power source 134, a global positioning system (GPS) chipset 136, and peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a microprocessor, one or more microprocessors in association with a DSP core, a controller, a microcontroller, an application specific integrated circuit (ASIC), a field programmable gate array (FPGA) circuit, an integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122, (e.g., multiple antennas), for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station, (e.g., base stations 114a, 114b), and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example core network 106 that may be used within the communications system 100 shown in FIG. 1A. As noted above, the RAN 104 may employ UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. The RAN 104 may include any number of Node-Bs and RNCs.

As shown in FIG. 1C, the Node-Bs 140a, 140b may communicate with one another and with the RNC 142a via respective Iub interfaces. Additionally, the Node-B 140c may communicate with the RNC 142b via an Iub interface. Each of the RNCs 142a, 142b may be configured to control the respective Node-Bs 140a, 140b, 140c to which it communicates with. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 1C may include a media gateway (MGW) 144, a mobile switching center (MSC) 146, a serving general packet radio service (GPRS) support node (SGSN) 148, and/or a gateway GPRS support node (GGSN) 150. While each of the foregoing elements are depicted as part of the core network 106, any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices. As noted above, the core network 106 may also be connected to the networks 112, which may include other wired or wireless networks that are owned and/or operated by other service providers.

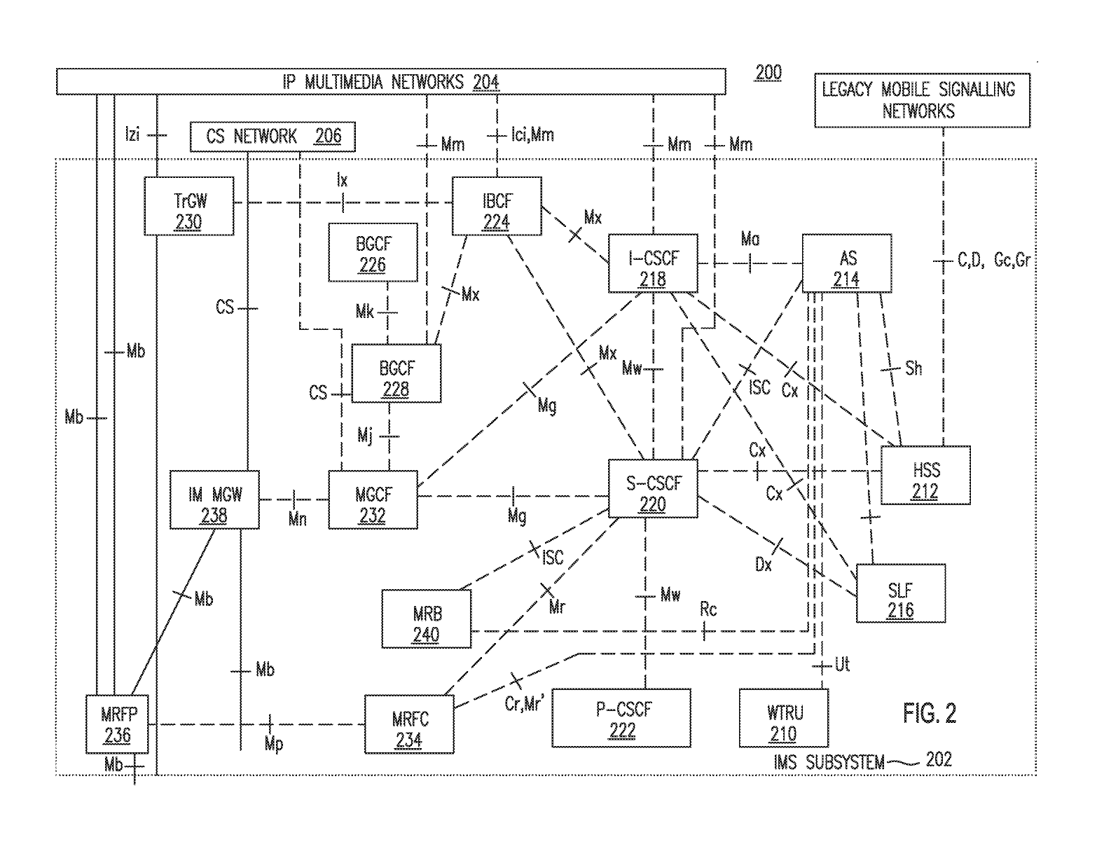

FIG. 2 shows an IMS architecture or Internet Protocol (IP) IP multimedia core network (IM CN) 200 comprising of a control plane and a user plane. The control plane is illustrated by dashed lines and used for signaling, while the user plane is illustrated by solid lines and used for user traffic. The IM CN 200 may include an IP Multimedia (IM) Subsystem (IMS) 202, an IM network 204, a Circuit Switched (CS) network 206, a legacy network 208, in communication with a wireless transmit/receive unit (WTRU) 210.

The IMS 202 may include core network (CN) elements for provision of IM services, such as audio, video, text, chat, or a combination thereof, delivered over the packet switched domain. As shown, the IMS 202 includes a Home Subscriber Server (HSS) 212, an Application Server (AS) 214, a subscriber location function (SLF) 216, an interrogating-Call Session Control Function (I-CSCF) 218, a serving-CSCF (S-CSCF) 220, a proxy-CSCF (P-CSCF) 222, an Interconnection Border Control Function (IBCF) 224, Breakout Gateway Control Function (BGCF) 226 and 228, a Transition Gateway (TrGW) 230, a Media Gateway Control Function (MGCF) 232, a Multimedia Resource Function Controller (MRFC) 234, a Multimedia Resource Function Processor (MRFP) 236, an IP Multimedia Subsystem-Media Gateway Function (IM-MGW) 238, and a Media Resource Broker (MRB) 240. In addition to the logical entities and signal paths shown in FIG. 2, an IMS 202 may include any other configuration of logical entities which may be located in one or more physical devices. Although not shown in this logical example, the WTRU may be a separate physical unit and may be connected to the IM CN 200 via a base station such as, a Node-B or an enhanced-NodeB (eNB).

The call session control functions (CSCFs) are key entities for session establishment, control and modification. The P-CSCF 222 is the first contact point within the IP CN 200, and it may be either in the visited network or in the home network. The P-CSCF 222 may behave like a proxy, accepting requests and serving them internally or forwarding them on. The I-CSCF 218 may be the contact point within an operator's network for all connections destined to a user of that network operator or a roaming user currently residing within that network operator's service area. The I-CSCF 218 may interact with HSS 212 and assign an S-CSCF 220 to serve the user according to information such as location and network load. The I-CSCFs 218 may reside in the home network. The S-CSCF 220 may perform the session control services for the WTRU 210. It may maintain a session state as needed by the network operator to support services. The S-CSCFs may reside in the home network. The interface between any two of CSCFs may be Mw, and the protocol used on Mw may be a Session Initiation Protocol (SIP).

The AS 214 may connect to the I-CSCF 218/S-CSCF 220 by Ma/ISC reference points to host and execute IMS services. The ASs 214 may be in a home network or in an external network, and may be IMS or third party owned. The Ma/IMS service control (ISC) reference points may be used to initiate, manage sessions, and exchange charging information. The protocol used on the Ma and ISC interfaces may be SIP.

The IMS architecture may provide efficient framework for handling and processing communications and connections. For example, it may provide an efficient framework for establishing multimedia connections between devices. The multimedia session may be split among devices. In another example, it may provide efficient framework for traffic distribution. When IMS connections are established, IMS entities in the CN may decide how data plane connections may be routed.

In another example, the IMS architecture may provide an efficient framework for end to end quality of service (QoS). The IMS protocol may allow IMS endpoints and the IM CN 200 to negotiate the QoS level prior to establishing a data plane connection. The QoS may also be modified during the existence of the data plane connection. In another example, the IM CN 200 may provide efficient framework for content-based charging. It may allow entities in the CN to monitor data connections, so that users can be charged online or offline based on the provided QoS, duration of connection, data type, and/or volume of data.

In another example, the IMS architecture may provide an efficient framework for inter-access network roaming. IMS may be transparent to the underlying access network and may support roaming between access networks, (e.g., 3GPP and Wi-Fi). Session mobility may be enabled for a user moving among multiple devices.

In another example, the IMS architecture may provide an efficient framework for architecture to easily adopt services. The IMS architecture may introduce the concept of application servers (AS). An AS may use the IMS infrastructure to provide application level services to IMS users or non-IMS users. The logic among AS′ may be customized.

In another example, the IMS architecture may provide an efficient framework for identifiers. It may provide infrastructure that facilitates addressing devices and applications via an SIP universal resource identifier (URI). The IMS architecture may provide an efficient framework for group management. Multiple SIP URIs may associate with a private user identity in IMS. Group related management may be customized as part of the subscription.

Machine Type Communication (MTC) is defined as communication among devices with little or no human intervention. MTC devices may be characterized as low resource and low data rate. The MTC applications may be commonly defined as delay-tolerant.

Some higher data rate MTC applications may be better suited for an IMS architecture, such as real-time applications, (e.g., real time video streaming applications, such as security monitoring), gateways (data aggregation), and QoS requirements. Gateways may sometimes be used to aggregate data from a large number of low end devices and route it to an MTC Server or another location for analysis. Although the amount of data from each individual device may be small, the amount of aggregated can be large. Some critical services may require QoS. For example, an MTC gateway that is located in a hospital may aggregate data from patient's medical sensors. The amount of raw data may be small, but it may also be critical that the data be delivered quickly and with guaranteed delivery.

QoS related features may be incorporated in release 2 and beyond. IMS CN may be used to provide QoS for machine-to-machine (M2M) services. Now that the operators are deploying IMS for providing QoS and multi-media services to end users, especially companies, it is believed that after the long term evolution (LTE) network is launched, IMS will be further more broadly deployed.

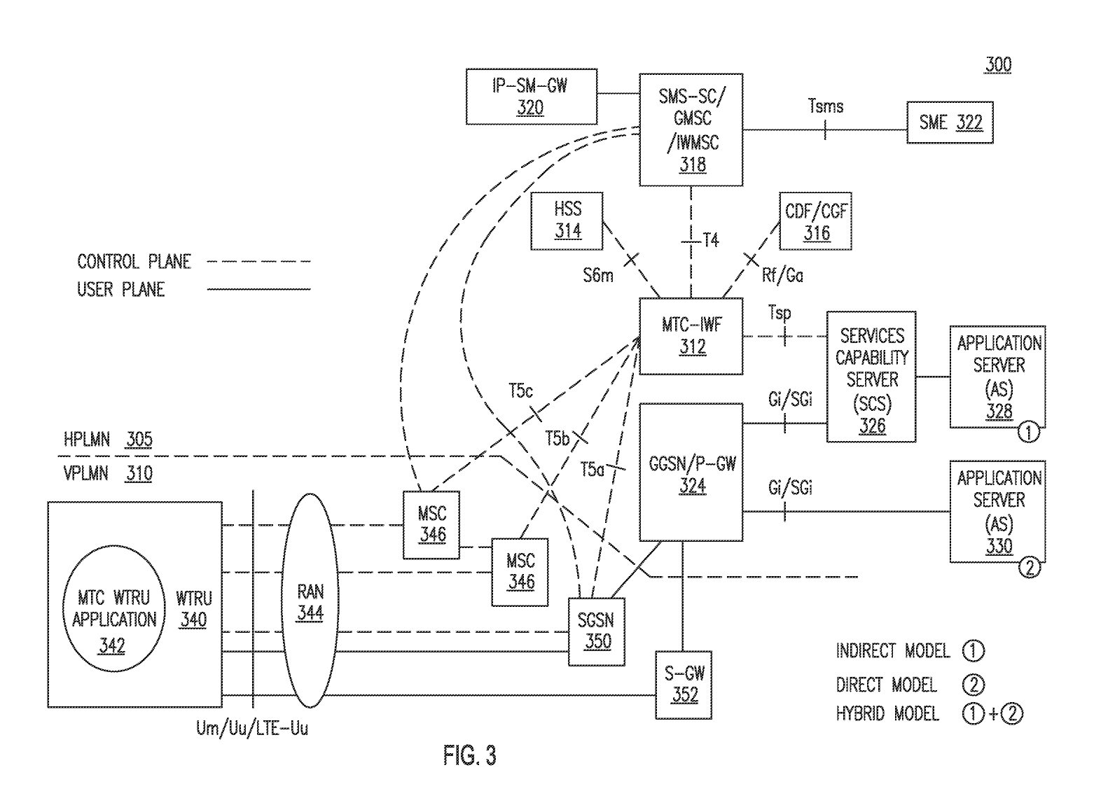

FIG. 3 shows a Third Generation Partnership Project (3GPP) machine-type communications (MTC) architecture 300. The MTC architecture 300 includes a home public land mobile network (HPLMN) 305 and a visited PLMN (VPLMN) 310. The HPLMN 305 includes a MTC interworking function (MTC-IWF) 312, a home subscriber server (HSS) 314, charging data function/charging gateway function (CDF/CGF) 316, a short message service-service center (SMS-SC)/gateway mobile switching center (GMSC)/interworking MSC (IWMSC) 318, an IP-short-message-gateway (IP-SM-GW) 320, a short message entity (SME) 322, gateway GPRS support node (GGSN)/packet data network gateway (P-GW) 324, a services capability server (SCS) 326, application servers (AS) 328 for indirect model, and AS 330 for direct model. The VPLMN 310 includes a WTRU 340 with a MTC WTRU application 342, a RAN 344, a MSC 346, a MME 348, a serving GPRS support node (SGSN) 350, and a serving gateway (SGW) 352,

The SCS 326 may offer services to MTC Applications. To support the indirect and hybrid models of MTC, one or more instances of an MTC-IWF 312 may reside in the HPLMN 305. The MTC-IWF 312 may operate in a 3GPP CN to trigger 3GPP WTRUs by T4 or T5 interfaces. The MTC-IWF 312 may receive triggering requests from an SCS 326 over Tsp, and perform mapping between the external identifier to an internal identifier, (e.g., International Mobile Subscriber Identity (IMSI)). Although the triggering functionality may be motivated by the growth of MTC applications and MTC devices, operators may wish to offer triggering services to non-MTC applications.

The Tsp reference point may connect an MTC-IWF 312 to one or more SCSs 326, support triggering functionality and report to the SCS 326 the success or failure of a trigger delivery. An MTC-IWF 326 may be a standalone entity or a functional entity of another network element. The MTC-IWF 312 may hide the internal PLMN topology and relays or translates signaling protocols used over Tsp to invoke specific functionality in the PLMN.

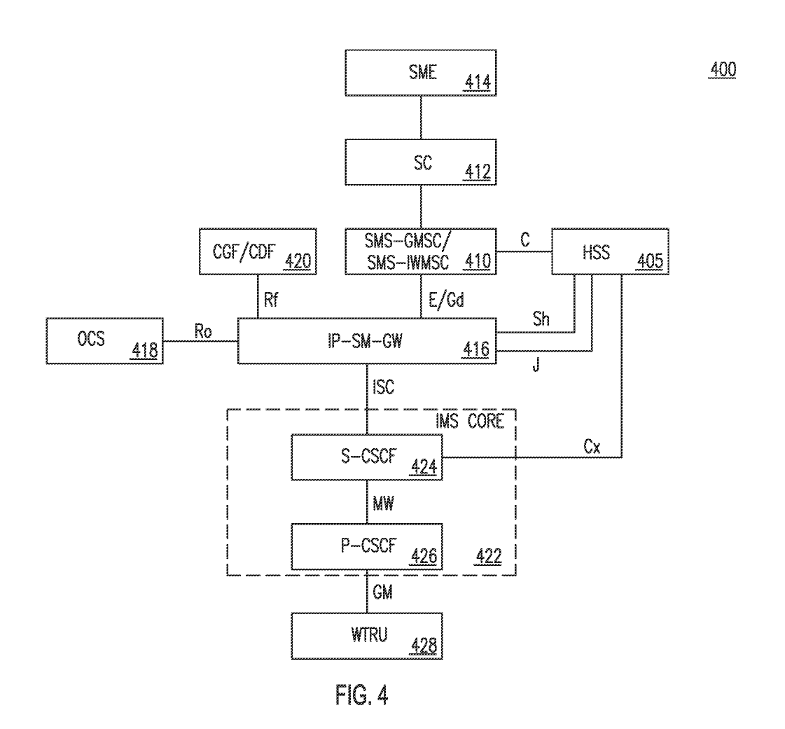

FIG. 4 shows an IMS short message service (SMS) architecture 400. The IMS SMS architecture 400 includes a HSS 405, a SMS-GMSC/SMS-IWMSC 410, a switching center (SC) 412, a SME 414, an IP-SM-GW 416, an online charging system (OCS) 418, a CGF/CDF 420, an IMS core 422 including a S-CSCF 424 and a P-CSCF 426, and a WTRU 428. The IP-SM-GW 416 may be an AS in an IMS domain to handle SMS. The Sh reference point between the HSS 405 and the IP-SM-GW 416 may pull or push profile records from the HSS 405. The MTC-IWF may send a trigger message to the IMS domain through the IP-SM-GW 416 so that it may be delivered to IMS registered WTRUs (or a particular application hosted on a IMS registered WTRU) if the SMS-SC 410 is not able to deliver the trigger in the 3GPP domain. However, the IP-SM-GW 416 may not deliver the trigger if the addressed WTRU is not registered to IMS.

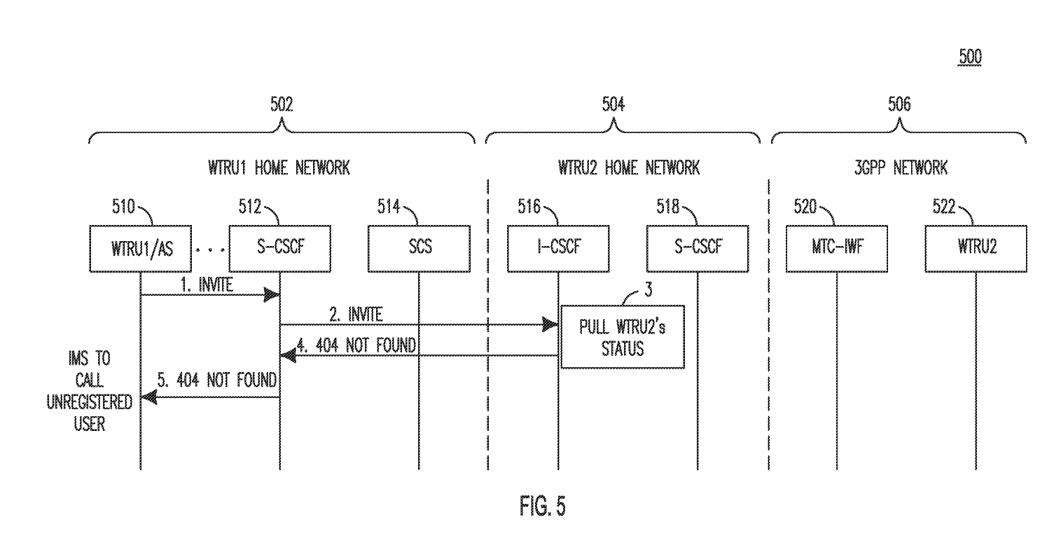

FIG. 5 shows IMS call flow 500 destined to an unregistered wireless transmit/receive unit (WTRU). A WTRU1 home network 502 may include a WTRU1 510, a S-CSCF 512 and a SCS 514. A WTRU2 home network 504 may include a I-CSCF 516 and a S-CSCK 518. A 3GPP network 506 may include a MTC-IWP 520 and a WTRU2 522. The WTRU1 510 may initiate a call to WTRU2 522 (1). The S-CSCF 512 of WTRU1 510 receives a SIP INVITE request form WTRU1. The I-CSCF 516 of WTRU2 522 receives the SIP INVITE request from S-CSCF 512 (2). The I-CSCF 516 queries or pulls the status of WTRU2 522 (3). The I-CSCF 516 will return a SIP message “404 Not Found” to S-CSCF 512 as WTRU2 522 is unregistered (4), which in turn will forward the SIP message to WTRU1 510.

There are cases where it would be more efficient to allow devices to de-register from the IMS CN during periods of inactivity, but remain reachable so that other IMS applications may request a session initiation. For example, it may be inefficient for a universal mobile telecommunications system (UMTS) device that communicates infrequently, such as a machine-type communications (MTC) device, to maintain its IMS registration and the associated overhead when not communicating. The associated overhead may include an active packet data protocol (PDP) context and an IP address. Additionally, the IMS or third generation partnership project (3GPP) CN may wish to schedule devices such that they do not all connect to the network at the same time.

In a 3GPP network, an MTC inter-working function (IWF) may perform triggering service where trigger messages can be sent when MTC devices/applications are not reachable from the 3GPP CN. Similarly, the IMS CN may trigger IMS devices/applications that are not registered to the IMS CN, but reachable from 3GPP CN through the MTC-IWF. The IMS applications that desire to initiate a session with another IMS application that is not registered in IMS may then trigger the un-registered application, thus prompting it to register. Currently, there is no triggering functionality available from the IMS domain.

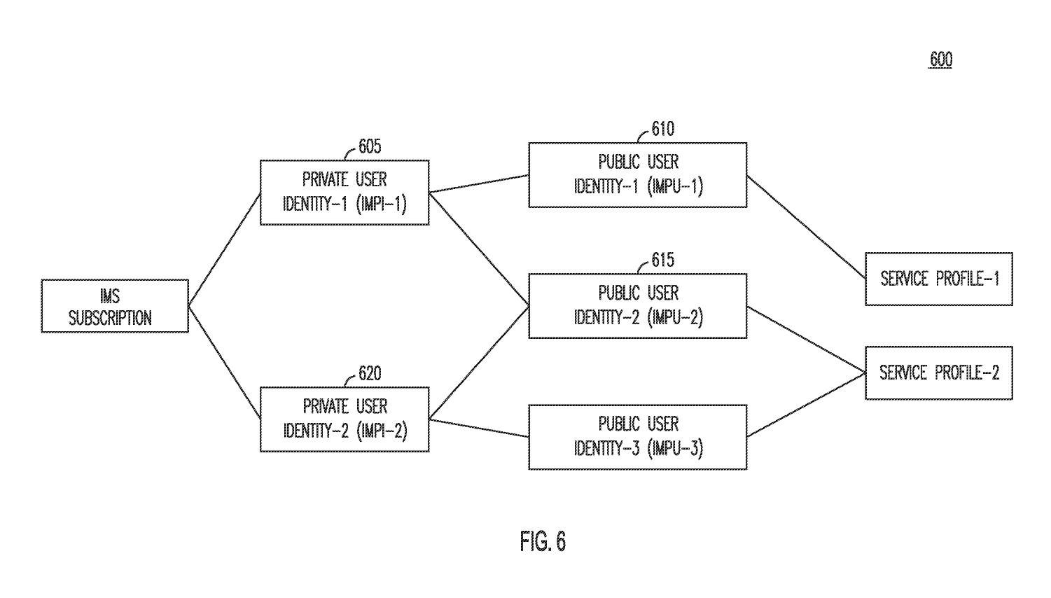

In addition, no matter which entity handles triggering service, there may be identifier ambiguity in IMS triggering service by a SIP uniform resource identifier (URI). As shown in FIG. 6, the current IMS identifier structure 600 is designed for users, not for devices. The IP multimedia private user identity (IMPI) may be assigned by the network operator and used for registration, authorization, administration and accounting purposes. The IMPI may not be used for routing SIP messages and may take the form of a network access identifier (NAI). Thus, it may not be possible for the WTRU to modify the IMPI information stored on the IMS subscriber identity module (ISIM) application or IMS credentials (IMC). Each IMS user may have one or more IP multimedia public user identity (IMPU) including at least one taking the form of a SIP URI. The IMPU may be used by any user for requesting communications to other users. One IMPI may correspond to multiple IMPUs. For example, IMPI-1 605 may correspond to IMPU-1 610 and IMPU-2 615.

In the IMS domain, an MTC device/application identifier may take the form of an IMPU. An IMPU may be registered before initiating or terminating sessions. One IMPU may correspond to multiple IMPIs. For example, IMPU-2 615 may correspond to IMPI-1 605 and IMPI-2 620. Also, not all IMPUs may be stored in the IMS home subscriber server (HSS). An unregistered IMPU may be either not stored in HSS or correspond to multiple IMPIs. Thus, when a trigger message is sent towards an IMPU not registered in IMS, both the IMS and 3GPP domains may not be able to map it to a 3GPP internal identifier, (e.g., international mobile subscriber identity (IMSI). Although a globally routable user agent URI (GRUU) may be the identifier in IMS to address a unique combination of an IMPU and a WTRU instance, it may be assigned during registration and may not be used for triggering without a valid IMS registration.

Described herein is an architecture which can efficiently support triggering service in the IMS domain and solve identifier ambiguity for triggering. The architecture is applicable to any service layer that interfaces to multiple access networks. Even though MTC devices are referred to herein, this architecture may be applied to any WTRU that supports these functionalities. To differentiate the HSS in the 3GPP domain and IMS domain, “IMS” or “3GPP” is placed in front of HSS. However, they may be the same physical entity or have some relationship.

In general, the architecture may include a triggering service server (TSS) architecture that may provide triggering services over multiple access networks. The TSS architecture may include a triggering identity function (TIF) that may maintain a database of device and application identifier mappings across multiple access networks, triggering capabilities, and triggering preferences and a triggering decision function (TDF) that may use information from the TIF and determine how triggers may be performed towards a device or a particular application hosted on a device.

The architecture may also include a new state that may be associated with IP multimedia public identities (IMPU). The IMPU may be an identifier for a device, user or application, and may have, for example, a uniform resource identifier (URI) format. This new state may be called “not-registered-triggerable” state and may indicate that user, device or application may receive triggers although the user, device or application is not currently registered in the IMS domain. The not-registered-triggerable” state is therefore associated with the user, device or application identifier.

The architecture may also have associated methods. An example method may be “unassisted triggering” which may allow IMS WTRUs and application servers (AS's) to deliver triggers directly towards other IMS devices and applications, which are not registered in IMS. Another example method may be “assisted triggering” which may allow an I-CSCF/S-CSCF to send trigger requests to the MTC-IWF, which is connected to the IMS CN as an AS, when a SIP INVITE message is sent towards an IMS device not registered in IMS. Another example method may be “assisted triggering” which may allow a P-CSCF to send trigger requests to the MTC-IWF which is connected to the P-CSCF via a new reference point, when a SIP INVITE message is sent towards an IMS device not registered in IMS. Another example method may be a triggering method which may allow an SCS to send trigger requests to an MTC-IWF from the IMS domain, where the SCS is connected to IMS as an AS or WTRU. This trigger request may be an unassisted triggering message or as a consequence of terminating a SIP INVITE message towards a WTRU not registered to IMS.

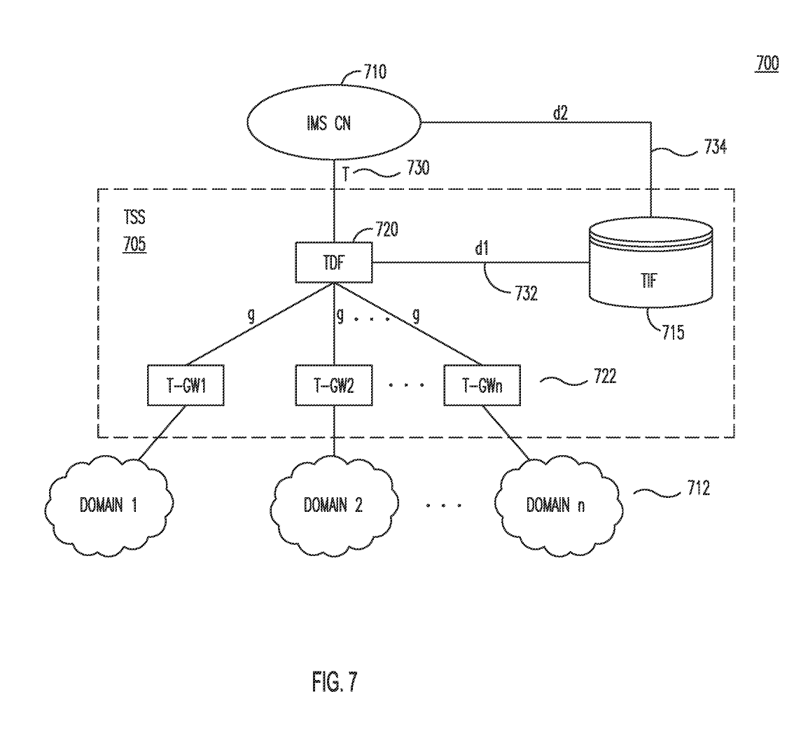

FIG. 7 illustrates an example TSS architecture 700 that may include a TSS 705 in communication with an access network 710 and multiple domains 1 . . . n 712. Although the TSS 705 is shown external to the access network 710, the TSS 705 may be internal/inside or external/outside the access network 710. The TSS 705 may include TIF 715, TDF 720 and triggering gateways (T-GWs) 1 . . . n 722 to perform triggering in different domains 712, such as 3GPP, powerline communication domains, and the like. The access network 710 may be an IMS CN, (as shown in FIG. 7), 3GPP, fixed broadband and the like. The T-GW 722 may be, for example, a MTC-IWF. The TSS 705 may be implemented as a new entity or as a service by adding TSS functionalities into existing entities.

To solve identifier ambiguities, the TIF 715 may serve as the database to maintain triggering related information and criterion. The TIF 715 may be internal/inside to the access network 710, external/outside to the access network 710 or as a front end interface that ties to multiple access networks. The reference point/interface between access network 710 and the TSS 705 is t 730. In particular, t 730 may connect TDF 720 to access network 710, an application server (AS), a machine-to-machine (M2M) server and the like. To make the triggering decision, TDF 720 may make use of the TIF 715 via d1 732 and d2 734 reference points, where d1 732 may indicate a direct interface to TIF 715 and d2 734 may be an indirect interface to TIF 715. An access network 710, AS, M2M server and the like may retrieve or update the information in TIF 715 via d2 734. The reference point/interface between TDF 720 and T-GWs 722 are g 736. The TSS 705 may be a logic entity and may be implemented in a distributed manner.

The TIF 715 may maintain the information described herein below. For example, it may maintain the not-registered-triggerable flag which is associated with an IMS domain identifier and described herein below. The IMS domain identifier may be the device, an application or user identifier. In another example, it may maintain the mapping information of an IMS domain identifier to one or more external triggerable identifiers, such as a 3GPP IMSI or MTC external identifier. These external triggerable identifiers may be access network specific identifiers that triggers can be sent to. In another example, it may maintain the triggering preference of an IMS domain identifier. The TIF 715 may indicate if the device or application does not want to be triggered or the TIF 715 may indicate which access network is preferred for triggering. In another example, the TIF 715 may maintain the triggering rules among different triggering domains. The TIF 715 may indicate parallel triggering, group triggering, delayed triggering or a sequence of triggering among different domains. In another example, the TIF 715 may maintain a triggering log, which may be used for charging. The records in TIF 715 may come from entities in IMS, such as an HSS. A user may subscribe to triggering service and provide its preferred triggerable identifier by subscription, or it may be based on another entity in other domains, (e.g., 3GPP HSS).

The TDF 720 may perform the following processes as described herein below. The TDF 720 may receive the trigger request from the IMS CN, exchange triggering related information with TIF 715 through d1 732 or d2 734 reference points, check whether the trigger request is valid and whether the sender is authorized to trigger based on the information from TIF 715. It may perform triggering to different domains according to the information in TIF 715. The trigger may be sent simultaneously or as a group to different domains or in sequence or delayed to some domains. The TDF 720 may obtain triggering responses from different triggering domains, generate charging related information, and provide a triggering report access network 710 and/or TIF 715.

The T-GW 722 may perform the following processes as described herein below. The T-GW 722 may send triggering messages to different domains, perform domain-related routing for triggering messages, perform congestion control/reliability for triggering messages, provide triggering delivery related information to TDF 720, and perform domain-related protocol mapping.

To facilitate or implement the architecture and examples described herein above, a “not-registered-triggerable” flag in TIF 715 may be used to indicate whether an identifier is triggerable or not. The identifier, for example, may be an IMS domain identifier. The “not-registered-triggerable” flag may be related to an IMS domain identifier, for example, IMPU. If an identifier is marked as “not-registered-triggerable”, there may be a valid external identifier, (for example, an IMSI or external MTC identifier), that may be used to trigger the corresponding device or application in other domains. The not-registered-triggerable flag is different from an “unregistered state” flag, where the IMPU is not registered but an S-CSCF is assigned for service as a consequence of a terminating request. Here, an IMPU with a not-registered-triggerable flag set as TRUE may not have an S-CSCF assigned.

The “not-registered-triggerable” flag may be set or disabled according to a number of scenarios as described herein below. For example, the “not-registered-triggerable” flag may be set or disabled by access network 710 through d2 734 according to subscription information of an IMS identifier in the access network, (for example, where the access network 710 may be a IMS domain). For example, a UMTS WTRU for MTC may subscribe to triggering service and set its IMSI, Mobile Station Integrated Services Digital Network (MSISDN), external identifier or the like as the triggerable identifier of all related IMPUs by subscription.

In another example, the “not-registered-triggerable” flag may also be set or disabled by access network 710 through d2 734 according to information in a registration/de-registration messages in the IMS domain. For example, a UMTS WTRU may set its one or more IMS identifiers to not-registered-triggerable when it de-registers from the IMS domain and provides a valid identifier to enable trigger in the 3GPP domain. In another example, the “not-registered-triggerable” flag may be set or disabled by access network 710 through d2 734 according to a network entity, such as an IMS AS, M2M server and the like.

In another example, the “not-registered-triggerable” flag may be set or disabled by access network 710 through d2 734 according to IMS signalling. For example, an IMS WTRU may send a “SUBSCRIBE” message to request set one or more of its IMS identifiers to not-registered-triggerable. In another example, the not-registered-triggerable flag may also be set by third party, including, but not limited to, M2M server, MME, SGSN, AS or the like. All of the examples described herein above may follow necessary authorization procedures.

For an IMS WTRU not registered to IMS, two models may be used to enable IMS triggering service to the 3GPP network, i.e., unassisted triggering and assisted triggering. Unassisted triggering may be applicable to the scenario where the WTRU or AS may obtain the registration status of the terminating WTRU and decide to trigger the terminating WTRU in other domains. In the assisted triggering model, the originating WTRU or AS may attempt to initiate a session with the terminating WTRU without knowing the terminating WTRU's registration status. The session invitation may include a triggering request indicator in the SIP INVITE message. The access network 710, (e.g, a IMS CN), would then attempt to trigger the terminating WTRU if it is not registered in the IMS domain. Additional triggering related information may be incorporated into SIP headers or into the SIP message payload.

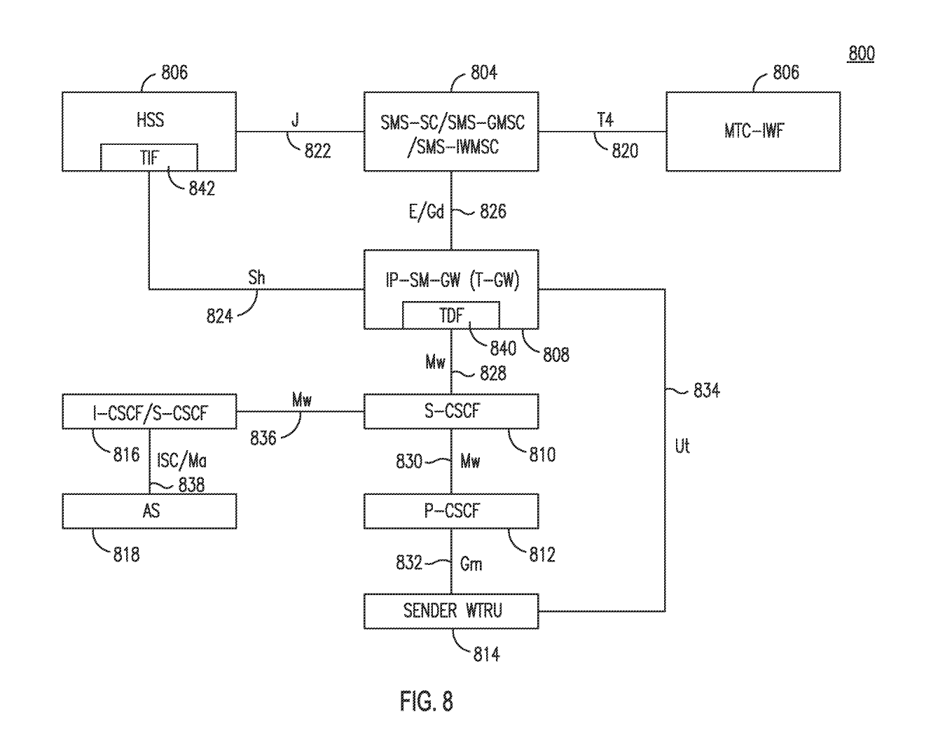

Described herein is unassisted triggering from IMS to 3GPP, (where triggers may be directly requested by an AS or WTRU via the existing IS C/Ma, Gm, or Ut reference points). FIG. 8 shows an unassisted triggering architecture 800. The unassisted triggering architecture 800 may be implemented by modifying the current IMS entities and related reference points. These entities and related reference points may include a MTC-IWF 802, a SMS-SC/SMS-GMSC/SMS-IWMSC 804, a HSS 806, a IP-SM-GW 808, a S-CSCF 810, a P-CSCF 812, a WTRU 814, an I-CSCF/S-CSCF 816 and an AS 818. These entities may be connected or interface via reference points T4 820, J 822, Sh 824, E/Gd 826, ISC 828, Mw 830, Gm 832, Ut 834, Mw 836, and ISC/Ma 838.

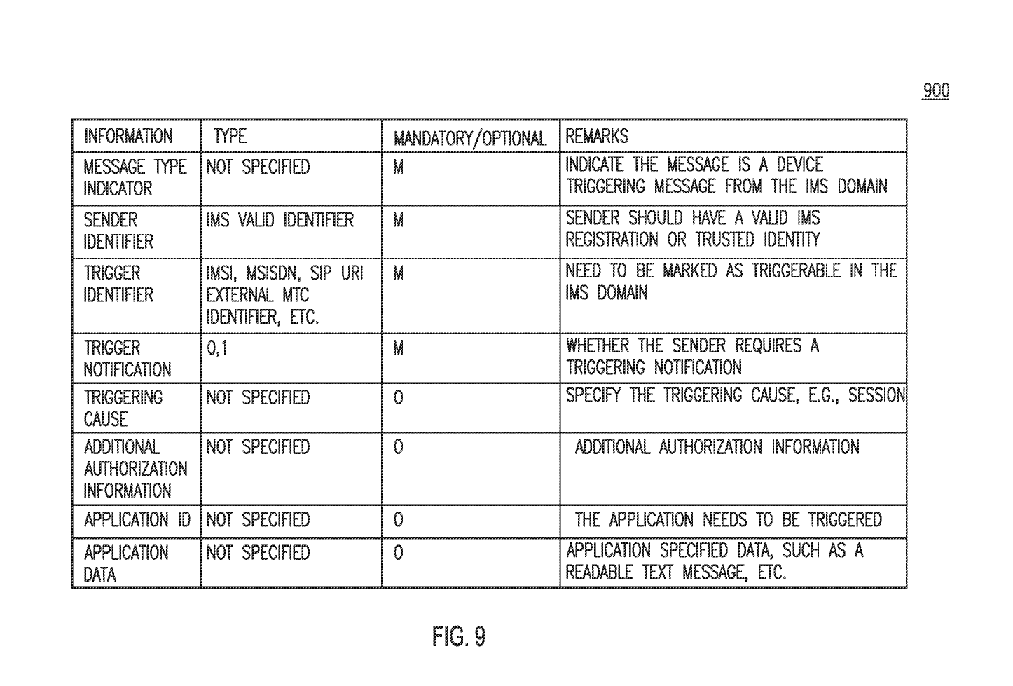

Both the originating WTRU 814 and AS 818 may be MTC devices registered to the IMS domain. The originating WTRU 814 or AS 818 may send an encapsulated triggering short message (TSM) in an SIP message via the Gm interface 832, or an hypertext transfer protocol (HTTP) message via the Ut interface 834 to IP-SM-GW 808, which is the entity in the IMS that provides SMS. A TDF 840 may be implemented as part of IP-SM-GW 808, which may be regarded as the T-GW to the 3GPP domain. A TIF 842 may be implemented, as part of HSS 806 or as a standalone entity. The d1 reference point may be mapped to Sh 824, and all other TSS reference points may be mapped as internal reference points of IP-SM-GW 808. The device/application to be triggered may be in the 3GPP domain. FIG. 9 shows information contained in a TSM in the SIP or HTTP message. The IP-SM-GW 808 may include additional information according to service profile.

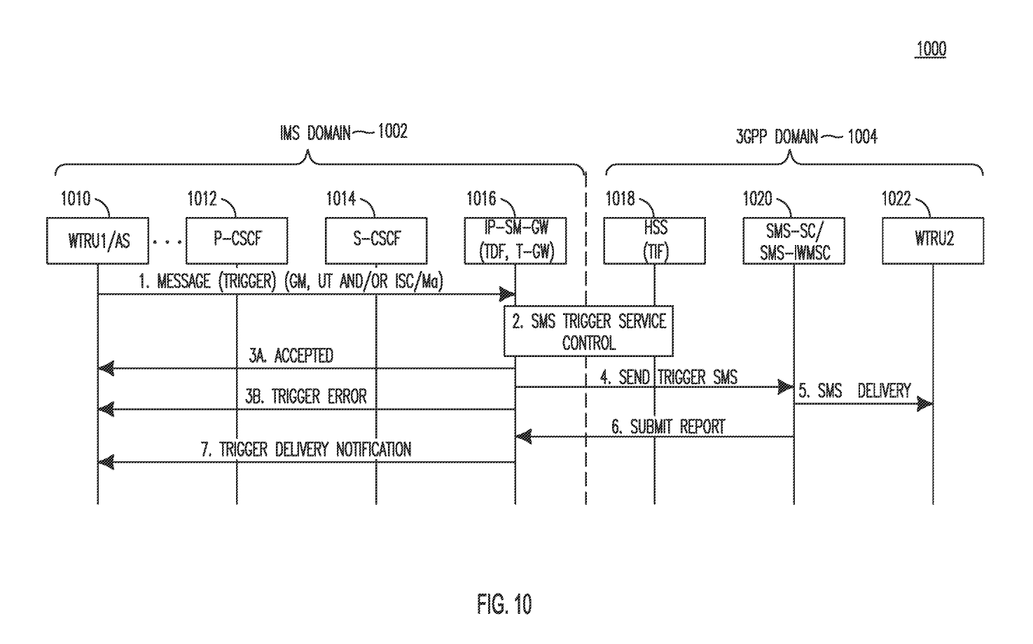

FIG. 10 shows an unassisted triggering call flow 1000 between entities in an IMS domain 1002 and a 3GPP domain 1004. The entities in the IMS domain 1002 may include a WTRU1/AS 1010, a P-CSCF 1012, a S-CSCF 1014, and a IP-SM-GW 1016. The entities in the 3GPP domain 1004 may include a HSS 1018, a SMS-SC/SMS-IWMSC 1020 and a WTRU2 1022.

The WTRU1/AS 1010 originates a trigger to WTRU2 1022 in the 3GPP domain 1004 (mobile originated (MO)). In particular, WTRU1/AS 101 submits the encapsulated triggering short message (TSM) to IP-SM-GW 1016 using an appropriate SIP method via Gm or HTTP method via Ut (1). If going through Ut, The message may not go through P-CSCF 1012 or S-CSCF 1014. The WTRU1/AS 1010 may perform related registration procedures or has trusted identity in the IMS domain 1002. The IP-SM-GW 1016 may send a provisional acknowledgement to the triggering request upon successfully/unsuccessfully sending the triggering message to SMS-SC 1020. If for any reason that IP-SM-GW 1016 cannot handle the triggering request, an error response with a failure reason may be sent to originating WTRU/AS 1010. After IP-SM-GW 1016 receives a delivery success/failure notification from SMS-SC 1020, a triggering notification may be sent from IP-SM-GW 1016 to originating WTRU/AS 1010 by SIP messages through CSCFs or HTTP message via Ut. Information related to delivery time, charging, error reason or subscription, and the like, may go into the notification. For simplicity, the provisional messages are omitted.

The IP-SM-GW (AS) 1016 performs service authorization based on the stored subscriber data (2). The IP-SM-GW 1016 may check whether the subscriber is authorized to use the short message service (SMS), (operator determined barring settings), and whether authorized to do device/application triggering, (similar to the authorization performed by MSC/SGSN in case the short message is delivered via circuit switched (CS) or packet switched (PS) domain). In addition, the IP-SM-GW (AS) 1016 may also check whether the user is authorized to use the encapsulated Short Message delivery via IMS. If the result of service authorization is negative, the IP-SM-GW 1016 may not forward the message, and may return the appropriate error information to the WTRU in a failure report. The IP-SM-GW (acting as AS) 1016 may check the Message Type Indicator and know it is a TSM message and forward it to TDF. The TDF may decide a trigger domain based on the triggering identifier and check whether the Not-Registered-Triggerable flag of its triggering identifier in TIF is enabled. If so, the TDF may let the IP-SM-GW (T-GW) 1016 extract the TSM and forward it towards the SMS-SC 1020 via the SMS-IWMSC interface using standard mobile application part (MAP) signaling.

The IP-SM-GW (TDF) 1016 may respond with an acknowledgement through the related CSCFs (3a). The IP-SM-GW (TDF) 1016 may acknowledge that it accepted the encapsulated TSM and an error occurred with a report of the reason (3b). In an embodiment, (3a) may occur for normal processing. In another embodiment, (3b) may occur for one type of error processing. In another embodiment, as shown in FIG. 10, IP-SM-GW (TDF) 1016 may accept the trigger, but some other issue prevented successful transmission of the trigger. The IP-SM-GW (AS) 1016 may send the TSM to the related SMS-SC/SMS-IWMSC 1020 (4). The SMS-SC/SMS-IWMSC 1020 may deliver the TSM to the addressed WTRU2 1022 to perform a trigger (5). The SMS-SC/SMS-IWMSC 1020 may send the submit report to IP-SM-GW (AS) 1016 (6). The IP-SM-GW (TDF) 1016 may send a triggering delivery notification to WTRU1/AS 1010, encapsulated in an appropriate SIP request or HTTP message (7).

Described herein is assisted triggering from IMS to 3GPP, (where triggers may be indirectly initiated by an AS or WTRU and delivered by IMS CN (access network) nodes). If the registration of the terminating WTRU is not known and the originating WTRU/AS attempts to initiate an IMS session, an assisted triggering may be performed by IMS CN nodes if the terminating WTRU is not registered in IMS. In 3GPP, the MTC-IWF is the entity that performs triggering services. The assisted triggering may be enabled by reusing MTC-IWF as a T-GW to implement TSS. The originating WTRU may indicate a triggering service request in a SIP message. For example, the caller may set the “Answer-Mode” header to indicate a triggering service request in the INVITE message. A TSM messages may go in the payload of the INVITE message or go in the header fields. Alternatively, the originating WTRU may subscribe to triggering service by subscription so that whenever the terminating WTRU is not registered in IMS, a trigger request may be sent on behalf of the originating WTRU.

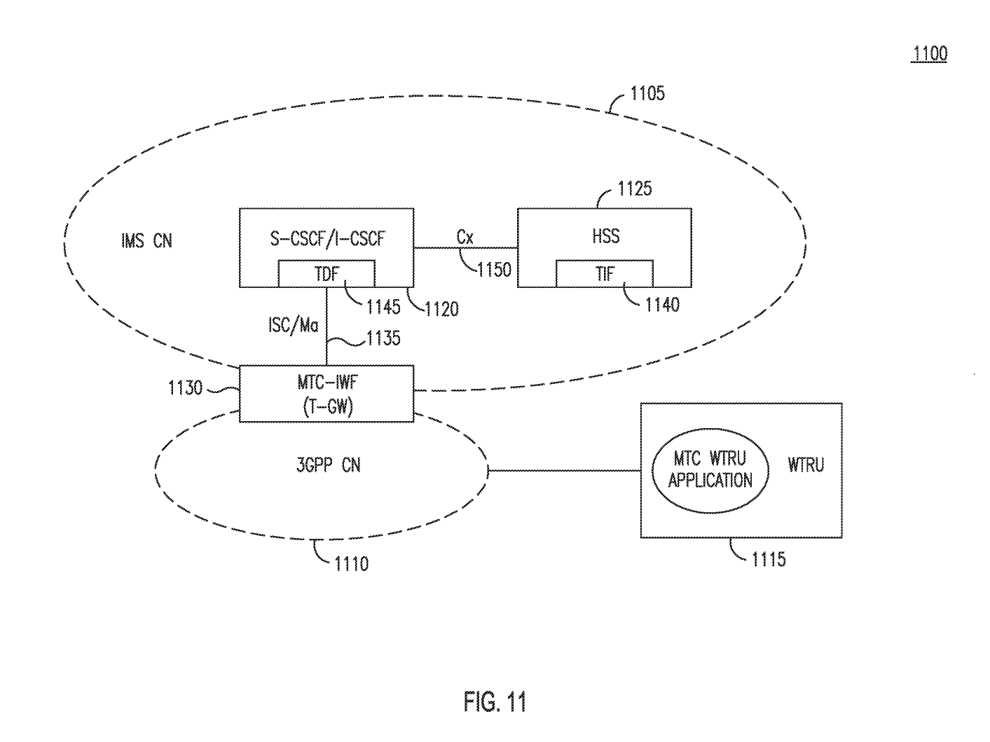

FIG. 11 shows TSS architecture 1100 which includes an access network 1105, a 3GPP CN 1110 and a WTRU 1115. The access network 1105 may be an IMS CN and may include a S-CSCF/I-CSCF 1120, a HSS 1125. The 3GPP CN 1110 may include a MTC-IWF 1130 which may be reused to implement a TSS. The MTC-IWF 1130 may be connected to the access network 1105 as an AS and may be regarded as the T-GW to the 3GPP domain 1110. The MTC-ITW 1130 acting as a T-GW may connect to S-CSCF/I-CSCF 1120 by ISC/Ma 1135 as an AS. A TIF 1140 may be implemented as part of the IMS HSS 1125 and a TDF 1145 may be implemented in I-CSCF/S-CSCF 1120. The d1 reference point may be mapped as Cx 1150 and at reference point may be mapped to ISC/Ma 1135.

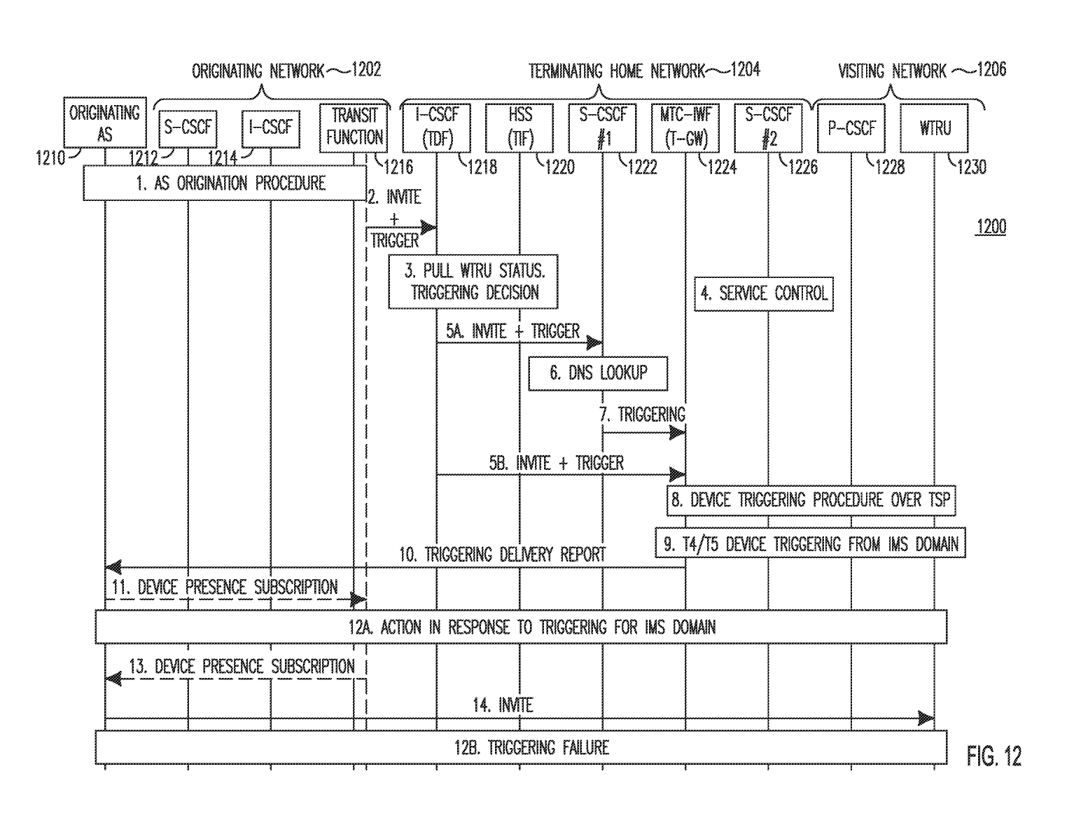

FIG. 12 shows an assisted triggering call flow 1200 between entities in an originating network 1202, a terminating home network 1204 and a visiting network 1206. The originating network 1202 may include an originating AS (AS-O) 1210, an S-CSCF 1212, I-CSCF 1214 and a transit function 1216. The terminating home network 1204 may include I-CSCF 1218, HSS 1220, S-CSCF#1 1222, MTC-IWF 1224, and S-CSCF#2 1226. The visited network 1206 may include a P-CSCF 1228 and a WTRU 1230.

In particular, what is shown is a call flow of TSS triggering by reusing MTC-IWF 1224. The call may originate from AS-O 1210 and a TDF may be implemented in I-CSCF 1218. The terminating WTRU 1230 may reside in the 3GPP domain and may not be registered in the IMS domain, the originating network 1202. For simplicity, the provisional messages may be omitted.

The AS-O 1210 follows the AS origination procedure to initiate a session to WTRU 1230 not registered in IMS domain (1). The AS-O 1210 may indicate the triggering option in the INVITE message and the TSM may go in the SIP header fields or payload. The INVITE with triggering option arrives at the I-CSCF 1218 in the WTRU's home network 1204 (2). The I-CSCF 1218 may look up registration status of the terminating WTRU 1230 in HSS 1220 and get “not registered” (3). Then the TDF in I-CSCF 1218 may make a triggering decision based on the triggering option in the SIP message and the terminating WTRU's service profile. The I-CSCF 1218 may retrieve information related to triggering from the HSS (TIF) 1220 instead of generating an error message. From HSS (TIF) 1220, the I-CSCF 1218 may get the “not-registered-triggerable” state of the terminating WTRU 1230 as TRUE. An S-CSCF#2 1226 may be assigned by I-CSCF 1218 to serve the not-registered WTRU 1230. The S-CSCF#2 1226 may download service related information of the terminating WTRU 1230 from HSS 1220 (4).

The I-CSCF 1218 may forward to S-CSCF#1 1222 serving the MTC-IWF 1224 to perform a trigger or the MTC-IWF 1224 directly to perform a trigger (5). The S-CSCF#1 1222 may do a Domain Name System (DNS) lookup to find a proper MTC-IWF (6). The S-CSCF#1 1222 may send a triggering request with the TSM to MTC-IWF 1224. Appropriate identity information, i.e., a valid internal identifier or a valid external identifier, may be included in the triggering request. Information about WTRU's action upon receiving the triggering may be included. The MTC-IWF 1224 may perform device/application triggering procedures (8).

The MTC-IWF (T-GW) 1224 may map the triggering request to appropriate protocol and send a trigger according the network's policies (9). The MTC-IWF 1224 may perform triggering according to the TSM received from the originating network 1202 (IMS CN) and include the appropriate message for WTRU 1230. The MTC-IWF (T-GW) 1224 may indicate the triggering is from the IMS domain (originating network 1202) and may avoid sending the triggering message to the IMS domain. The MTC-IWF (T-GW) 1224 may send a triggering delivery report to AS-O 1202 with information such as triggering interface, charging related information, WTRU's scheduling information, and the like (10). Upon receiving the triggering delivery report, WTRU 12302 may terminate the pending SIP transaction or make changes to the timers and wait for further reply from the terminating WTRU 1230. The AS-O 1210 may optionally subscribe to the event related to the WTRU 1230. e.g., presence status (11).

The triggering response may be according to the triggering message from the IMS domain (12a). The WTRU 1230 may perform proper action in response to the triggering message. For example, the WTRU 1230 may register to the IMS domain. Alternatively, the triggering response may be based on some criterions, and a triggering failure with description of reason may be sent to the AS-O (12b). If the AS-O 1210 may subscribe to the event related to the WTRU 1230, it may get a notification message (13). If the original SIP transaction is terminated, according to some information like the terminating WTRU's 1230 notification or timer, the AS-O 1210 may re-send an INVITE (14). The triggering message may be accordance with the list of FIG. 9.

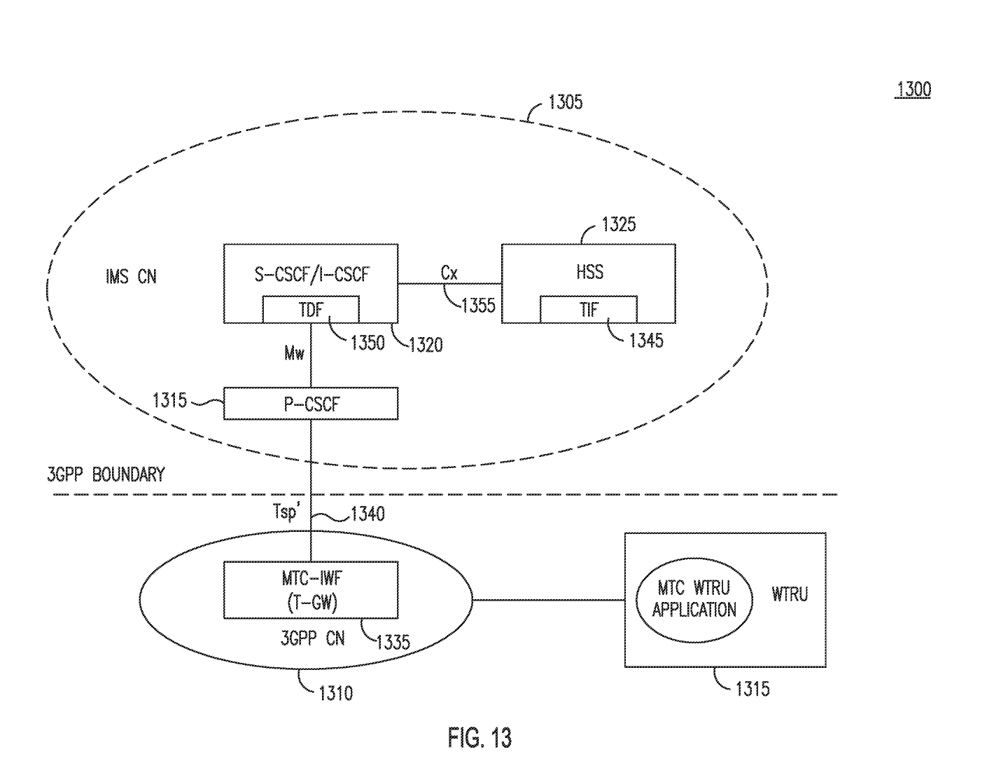

FIG. 13 shows a TSS architecture 1300 which includes an access network 1305, a 3GPP CN 1310 and a WTRU 1315. The access network 1305 may be an IMS CN and may include a S-CSCF/I-CSCF 1320, a HSS 1325 and a P-CSCF 1330. The 3GPP CN 1310 may include a MTC-IWF 1335 which may connect to P-CSCF 1330 in the IMS domain 1305. The MTC-IWF 1335 may be regarded as the T-GW to the 3GPP domain 1310, which may connect to P-CSCF 1330 by Tsp′ 1340. The Tsp′ 1340 may be based on current interfaces in UMTS or IMS, e.g., Tsp or Gm. A TIF 1345 may be implemented as part of HSS 1325 and a TDF 1350 may be implemented in I-CSCF/S-CSCF 1320. The d1 reference point may be mapped as Cx 1355, and the t reference point may be mapped to Tsp′ 1340.

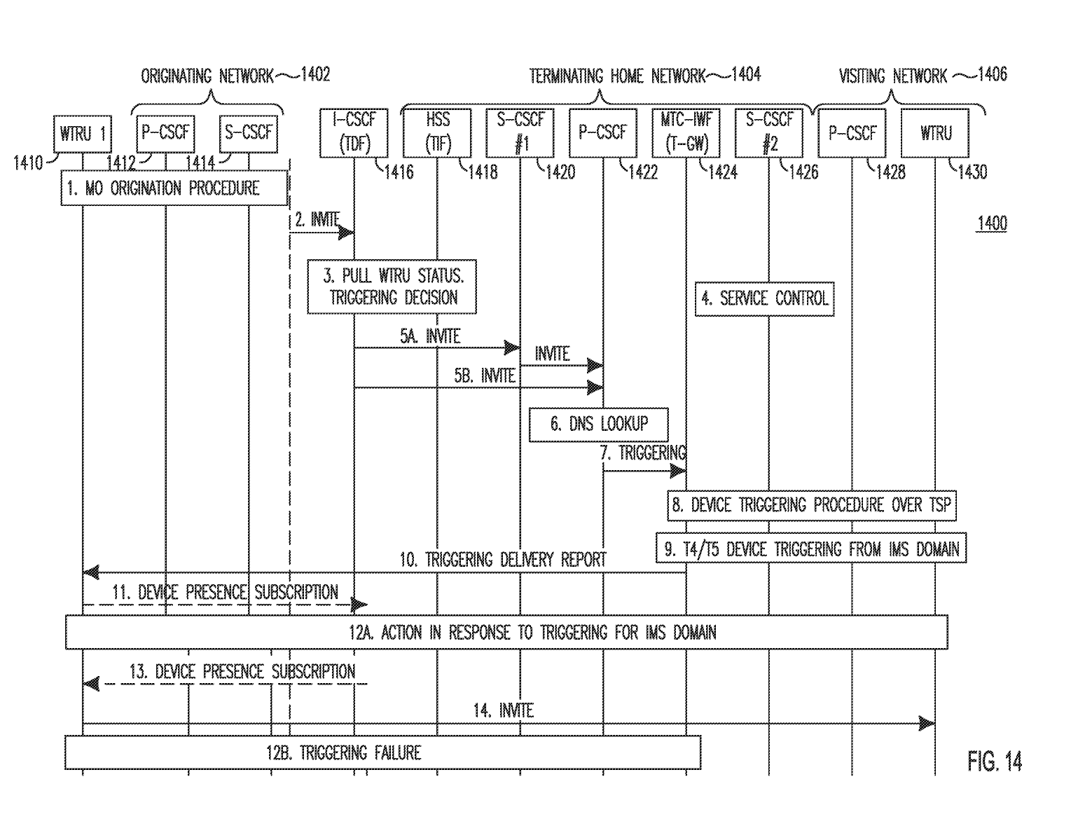

FIG. 14 shows a call flow 1400 of TSS between entities in an originating network 1402, a terminating home network 1404 and a visiting network 1406. The originating network 1402 may include a WTRU 1410, a P-CSCF 1412 and an S-CSCF 1414. The terminating home network 1404 may include I-CSCF 1416, HSS 1418, S-CSCF#1 1420, P-CSCF 1422, MTC-IWF 1424, and S-CSCF#2 1426. The visited network 1206 may include a P-CSCF 1428 and a WTRU2 1430.

In particular, what is shown is a call flow of TSS triggering by reusing MTC-IWF 1424 for a mobile originated (MO) trigger. A TDF may be implemented in I-CSCF 1416 and the call may originate from WTRU1 1410. The WTRU2 1430 may reside in the 3GPP network and not be registered to the IMS domain.

The originating WTRU1 1410 follows the MO procedure to initiate a session to WTRU2 1430 (1). The WTRU1 1410 may indicate the triggering option in the INVITE message. The INVITE with triggering option arrives at the I-CSCF 1416 in the WTRU2's home network 1404 (2). The I-CSCF 1416 may look up registration status of WTRU2 1430 in HSS 1418 (3) and get “not registered”. Then the TDF in I-CSCF 1416 may make a triggering decision based on the triggering option in the SIP message and the terminating WTRU2's 1430 service profile. The I-CSCF 1416 may retrieve information related to triggering from the TIF instead of generating an error message. From TIF, the I-CSCF 1416 may get the “not-registered-triggerable” state of the terminating WTRU 1430 as TRUE. An S-CSCF#2 1428 may be assigned by I-CSCF 1416 to serve WTRU2 1430. The S-CSCF#2 1428 may download service related information of WTRU2 1430 from the HSS 1418 (4).

The I-CSCF 1416 may forward to S-CSCF#1 1420 serving the MTC-IWF 1424 to perform a triggering (5a). The I-CSCF 1416 may forward to P-CSCF 1422 in the network where MTC-IWF 1424 connects to perform a triggering (5b). The P-CSCF 1422 may do a DNS lookup to find a proper MTC-IWF 1424 (6) and may send a triggering request with TSM to MTC-IWF 1424 (7). Appropriate identity information, i.e., a valid external identifier, may be included in the triggering request. Information about WTRU2's 1430 action upon receiving the triggering may be included.

The MTC-IWF 1424 may perform triggering procedures in accordance with current triggering procedures (8). The MTC-IWF 1424 acting as a T-GW, may map the triggering request to appropriate protocol and send the trigger according the network's policies (9). The MTC-IWF (T-GW) 1424 may perform triggering according to a TSM received from the IMS CN and include the appropriate message for WTRU2 1430. The MTC-IWF 1424 may indicate the triggering is from IMS domain and may avoid sending the triggering message to the IMS domain. The MTC-IWF (T-GW) 1424 may send a triggering delivery report to the originating WTRU1 1410 with information such as triggering interface, charging related information, WTRU2's 1430 scheduling information, and the like (10). Upon receiving the triggering delivery report, WTRU11410 may terminate the pending SIP transaction or make changes to the timers and wait for further reply from the terminating WTRU2 1430. The WTRU1 1410 may optionally subscribe to the event related to the WTRU2 1430, e.g., presence status (11).

The triggering response may be according to the triggering message from the IMS domain (12a). The WTRU2 1430 may perform proper action in response to the triggering message. For example, the WTRU2 1430 may register to the IMS domain. The triggering response may be based on some criterions (12b). A triggering failure with description of a reason may be sent to the originating WTRU1 1410. If WTRU1 1410 may subscribe to the event related to WTRU2 1430, it may get a notification message (13). If the original SIP transaction is terminated, according to some information like the terminating WTRU2's 1430 notification or timer, WTRU1 1410 may re-send an INVITE (14).

Described herein are triggering IMS devices or applications via a service capability server (SCS). The SCS may make trigger requests to the 3GPP CN through a Tsp reference point. If a SCS is accessible from the IMS domain, it may perform triggering for other WTRU or AS through both unassisted triggering and assisted triggering. To perform unassisted triggering, the SCS may be considered as an AS in the IMS domain.

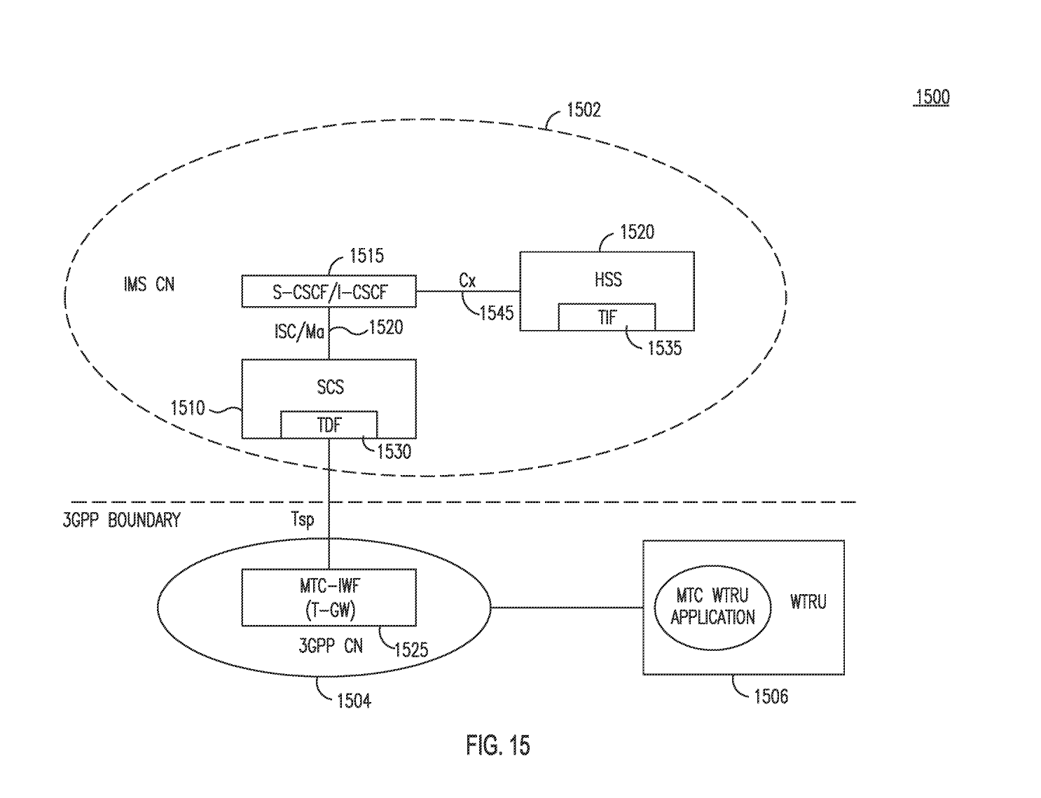

FIG. 15 shows a SCS trigger architecture 1500 which includes an access network 1502, (an IMS CN), a 3GPP CN 1504 and a WTRU 1506. The access network 1502 may include a SCS 1510, a S-CSCF/I-CSCF 1515, and a HSS 1520. The 3GPP CN 1504 may include a MTC-IWF 1525. The MTC-IWF 1525 may be regarded as a T-GW in 3GPP CN domain 1504. A TDF 1530 may be implemented in SCS 1510 and may make use of a TIF 1535 via a d2 reference point, which is mapped into ISC/Ma 1540 and Cx 1545.

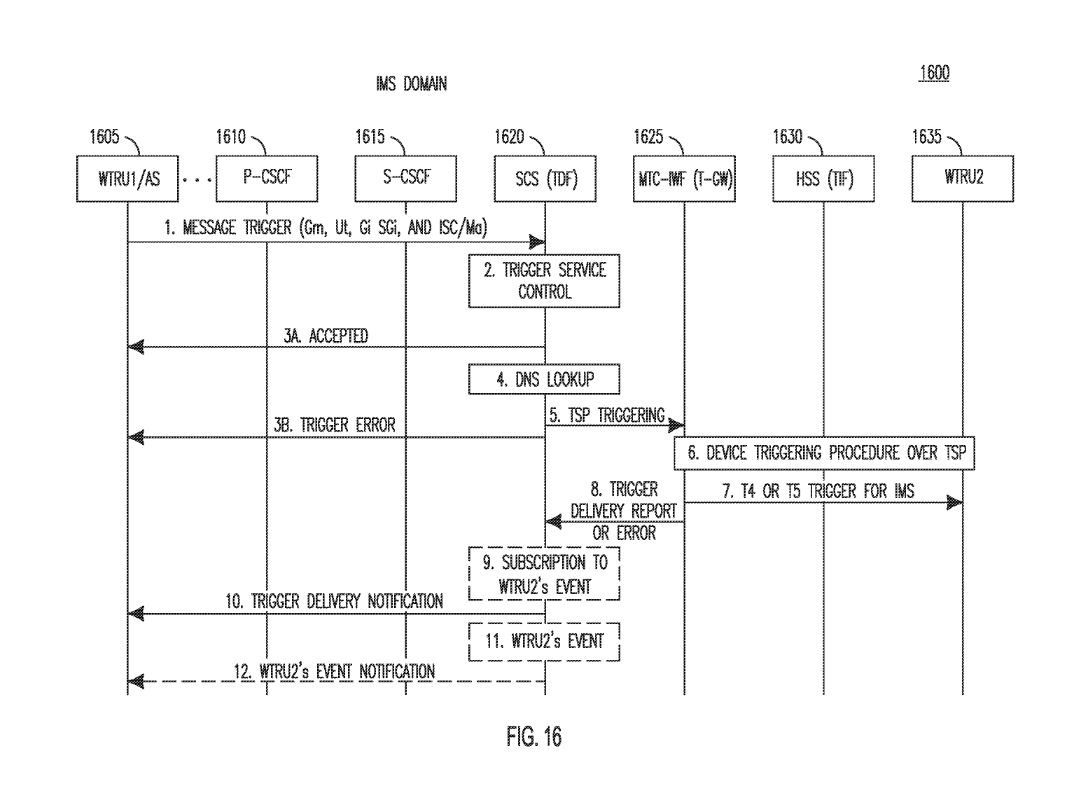

FIG. 16 shows a call flow 1600 for unassisted triggering through an SCS. The call flow 1600 may be between WTRU1/AS 1605, P-CSCF 1610, S-CSCF 1615, SCS 1620, MTC-IWF 1625, HSS 1630 and WTRU2 1635. The SCS 1620 may have interfaces to other domains, such as Wifi. The WTRU1 1605 may submit an encapsulated triggering message to SCS 1620 using an appropriate protocol through an appropriate reference point, such as SIP, HTTP and the like (1). The message may not go through P-CSCF 1610 or S-CSCF 1615. The SCS 1620 may perform service authorization based on internal or external information, e.g., HSS 1630 or TIF. The SCS 1620 may check whether the subscriber is authorized to use IMS domain triggering service, (e.g., operator determined barring settings) (2). If the result of service authorization is negative, the SCS 1620 may not forward the message, and may return the appropriate error information to the originating WTRU/AS 1605 in a failure report. Otherwise, a TDF may make a triggering decision based on the information in TSM and the service profile in TIF.

The SCS may respond with an acknowledgement through the related CSCFs. SCS may acknowledge to accept the trigger request (3a) or an error occurred with a report of the reason (3b). The SCS 1620 may do a DNS lookup to find a proper MTC-IWF (T-GW) (4). If the “not-registered-triggerable” flag of the terminating WTRU2 1635 is set as TRUE, the SCS 1620 may send a trigger with the information in TSM through Tsp (5). Additional information may be added to the triggering message. The SCS 1620 may send a trigger request to the MTC-IWF (T-GW) 1625. The MTC-IWF (T-GW) 1625 may perform trigger procedure over Tsp (6).

The MTC-IWF (T-GW) 1625 may indicate the trigger comes from IMS domain when performing triggering to avoid SMS-SC sending the trigger to IMS domain (7). The MTC-IWF (T-GW) 1625 may send a success/failure triggering delivery notification to the SCS 1620 (8). The SCS 1620 may subscribe to terminating WTRU2's 1635 event, e.g., registration status (9). The SCS 1620 may send a triggering delivery notification to the originating WTRU1 1605 including related information about the trigger (10). The SCS 1620 may get a notification upon WTRU2's 1635 event (11). The SCS 1620 may send a notification upon WTRU's event if necessary (12).

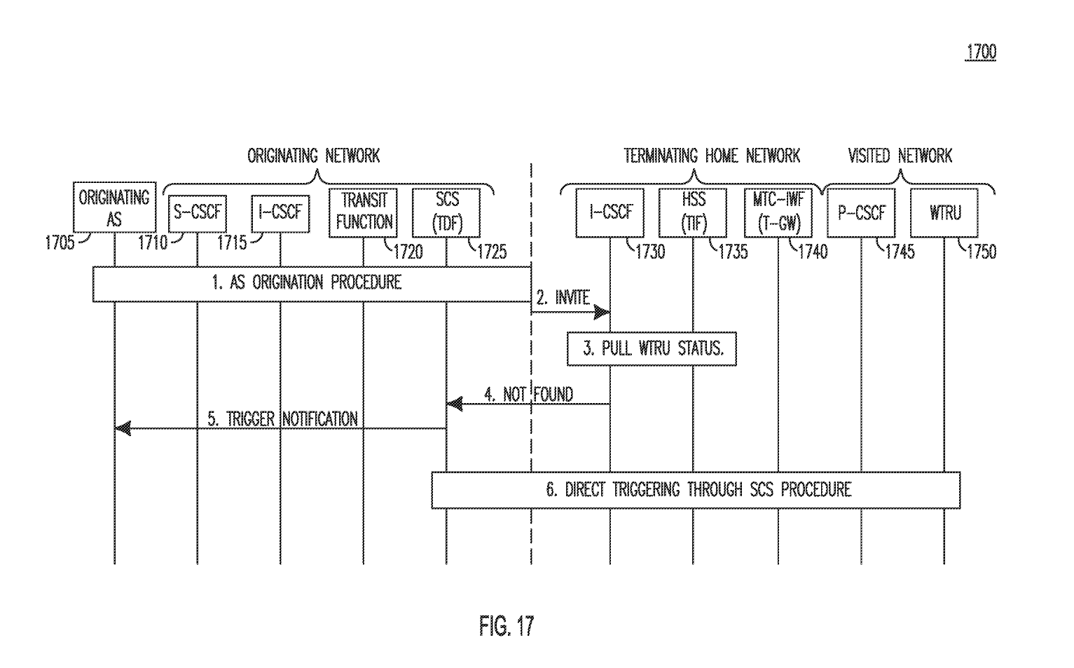

FIG. 17 shows call flow 1700 between originating AS 1705, S-CSCF 1710, I-CSCF 1715, transit function 1720, SCS 1725, I-CSCF 1730, HSS 1735, MTC-IWF 1740, P-CSCF 1745 and WTRU 1750. The call flow 1700 illustrates assisted triggering through SCS 1725 from originating AS 1705 to an unregistered WTRU 1750, where a TDF is optionally implemented in SCS 1725. The SCS 1725 is shown in the originating AS's home network 1702 and the terminating WTRU 1750 is connected to a 3GPP network.

The originating AS 1705 may perform the AS-O procedure and indicate that a trigger may be performed (1). The indication may be in the INVITE message, e.g., in the header or payload. The originating signaling may need to be forwarded to SCS 1725 according to service profile, so that the following SIP responses may also pass to the SCS 1725 to help TDF's triggering decision. The INVITE message would be forwarded to I-CSCF 1730 in the terminating WTRU's 1750 home network 1704 (2). The I-CSCF 1730 may obtain the terminating WTRU's 1750 status as “unregistered” from HSS 1735 (3). The I-CSCF 1730 may respond to the INVITE message with an error message, (e.g., “404 not found”) (4). If the “not-registered-triggerable” state of the terminating WTRU 1750 in TIF is set as TRUE, the TDF may make a triggering decision (5). The SCS 1725 may send a trigger notification to the originating AS 1705 to indicate a trigger decision. The trigger notification may include information such as charging and trigger reason, and the like. The SCS 1725 may perform the unassisted triggering procedure as shown in FIG. 12 or 14 (6).

Although features and elements are described above in particular combinations, one of ordinary skill in the art will appreciate that each feature or element may be used alone or in combination with any of the other features and elements. In addition, the embodiments described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, a cache memory, a semiconductor memory device, a magnetic media, (e.g., an internal hard disc or a removable disc), a magneto-optical media, and an optical media such as a compact disc (CD) or a digital versatile disc (DVD). A processor in association with software may be used to implement a radio frequency transceiver for use in a WTRU, UE, terminal, base station, Node-B, eNB, HNB, HeNB, AP, RNC, wireless router or any host computer.

What is claimed:

1. A triggering service server (TSS) for providing triggering services over multiple access networks, comprising:
a triggering identity function (TIF) configured to maintain a database of device and application identifier mappings across the multiple access networks, triggering capabilities, and triggering preferences;
a triggering decision function (TDF) configured to use information from the TIF and determine how triggers should be performed for an entity having a not-registered-triggerable status with respect to one of the multiple access networks; and
a plurality of triggering gateway (T-GWs) configured to perform triggering in different domains and send triggering response information from the different domains to the TDF.

2. The TSS of claim 1, wherein the TSS is one of internal or external to an access network.

3. The TSS of claim 1, wherein the TIF is one of internal to an access network, external to an access network or a front end interface tied to the multiple access networks.

4. The TSS of claim 1, wherein the TIF is configured to maintain a not-registered-triggerable flag associated with an entity identifier, wherein the entity is one of a device, application or user.

5. The TSS of claim 4, wherein the TIF is configured to maintain mapping information of the entity identifier to one or more external triggerable identifiers.

6. The TSS of claim 4, wherein the TIF is configured to maintain the triggering preference of the entity identifier.

7. The TSS of claim 1, wherein the TIF is configured to maintain triggering rules among different triggering domains.

8. The TSS of claim 1, wherein the TDF is configured to receive a trigger request from an access network.

9. The TSS of claim 8, wherein the TDF is configured to determine validity of a trigger request and sender authorization based on information received from the TIF.

10. The TSS of claim 1, wherein the TDF is configured to perform triggering to the different domains according to information received from the TIF.

11. The TSS of claim 1, wherein each T-GW is configured to perform domain-related routing for triggering messages, congestion control/reliability for triggering messages, provide triggering delivery related information to the TDF, and perform domain-related protocol mapping.

12. A method for triggering, comprising:
receiving a request from an originating network to have a session with an entity that is not-registered in the originating network and is triggerable;
making a triggering decision at a triggering decision function (TDF) using information from a triggering identity function (TIF) to determine how a trigger should be performed for the entity having a not-registered-triggerable status with respect to the originating network, wherein the TIF maintains a database of device and application identifier mappings across multiple access networks, triggering capabilities, and triggering preferences;
transmitting a triggering request to a triggering gateway (T-GW); and
receiving triggering delivery information from the T-GW.

13. The method of claim 12, wherein the TIF is one of internal to an access network, external to an access network, or a front end interface tied to the multiple access networks.

14. The method of claim 12, wherein the TIF maintains a not-registered-triggerable flag associated with an entity identifier, wherein the entity is one of a device, application or user.

15. The method of claim 12, wherein the TIF maintains mapping information of the entity identifier to one or more external triggerable identifiers.

16. The method of claim 12, wherein the TIF maintains the triggering preference of the entity identifier.

17. The method of claim 12, wherein the TIF maintains triggering rules among different triggering domains.

18. The method of claim 12, wherein the TDF validates trigger request and sender authorization based on information received from the TIF.

19. The method of claim 12, wherein the T-GW performs domain-related routing for triggering messages, congestion control/reliability for triggering messages, provides triggering delivery related information to the TDF, and performs domain-related protocol mapping.

20. The method of claim 12, further comprising:
transmitting triggering report to at least one of the TIF and the originating network.
